(19) United States
(12) Patent Application Publication
(10) Pub. No.: US 2007/0227033 A1
(43) Pub. Date: Oct. 4, 2007

(54) SUBSTRATE TRANSFERRING APPARATUS, SUBSTRATE PROCESSING APPARATUS, AND SUBSTRATE PROCESSING METHOD

(75) Inventors: Yoshiyuki Kobayashi, Nirasaki-shi (JP); Itsuko Sakai, Yokohama-shi (JP); Tokuhisa Ohiwa, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignees: TOKYO ELECTRON LIMITED, Tokyo (JP); Kabushiki Kaisha Toshiba, Tokyo (JP)

(21) Appl. No.: 11/692,379

(22) Filed: Mar. 28, 2007

(30) Foreign Application Priority Data
Mar. 30, 2006 (JP) 2006-095634

(51) Int. Cl. F26B 5/04

(52) U.S. Cl. 34/406

(57) ABSTRACT

A substrate transferring apparatus capable of suppressing particles from being produced. The substrate processing apparatus (1) includes a processing chamber (12) in which a wafer (W) is housed, a transfer arm (17) for transferring the wafer to the processing chamber, and a susceptor (45) which is disposed in the processing chamber and on which the transferred wafer is mounted. An electrostatic chuck (55) having a plurality of protrusions (55a) is disposed In an upper portion of the susceptor. A transfer fork (25) having a plurality of protrusions (25a) for holding a wafer is disposed on a distal end of the transfer arm. These protrusions (25a) are provided in the transfer fork (25) such that wafer holding portions (81) by the protrusions (25a) are different from wafer holding protrusions (80) by the protrusions (55a) of the electrostatic chuck.

### BACKGROUND OF THE INVENTION

1. Field of the Invention

The present invention relates to a substrate transferring apparatus, a substrate processing apparatus, and a substrate processing method, and more particularly, to a substrate transferring apparatus for transferring to-be-processed substrates, a substrate processing apparatus including the substrate transferring apparatus, and a substrate processing method for the substrate processing apparatus.

2. Description of the Related Art

A substrate processing apparatus that carries out plasma processing such as etching processing on wafers as to-be-processed substrates has a housing chamber in which a wafer is housed, a transfer arm that transfers a wafer to the housing chamber, and a stage that is disposed in the housing chamber and on which the wafer is mounted. In such a substrate processing apparatus, plasma is produced in the housing chamber, and the wafer is subjected to the etching processing by the plasma.

The stage has in an upper portion thereof an electrostatic chuck comprised of an insulating member having an electrode plate therein, the wafer being mounted on the electrostatic chuck. While the wafer is being subjected to the etching processing, a DC voltage is applied to the electrode plate, the electrostatic chuck attracting the wafer thereto through a Coulomb force or a Johnsen-Rahbek force generated by the DC voltage.

A sprayed coating is formed on the electrostatic chuck by spraying ceramics such as alumina onto a surface of the electrostatic chuck. A wafer is placed on the surface of the electrostatic chuck coated with the sprayed coating.

Since the surface of the electrostatic chuck coated with the sprayed coating is brittle, contact parts between the chuck surface and a wafer placed thereon are worn to produce particles, which are attached to a rear surface of the wafer. When the wafer is transferred, these particles attached to the wafer rear surface are in physical contact with the transfer arm and peeled off from the rear surface of the wafer, resulting in increase in amount of particles produced in the substrate processing apparatus, thereby lowering the product yield from the substrate processing apparatus.

To reduce particles attached to the rear surface of a wafer, in recent years, there has been proposed an electrostatic chuck having a plurality of protrusions adapted to hold a wafer (refer to Japanese Patent Laid-open Publication No. 2005-191561, for example).

In some cases, foreign matters such as reaction products produced during plasma processing are accumulated on an outer peripheral edge portion of a wafer having been subjected to the plasma processing.

To prevent particles caused by the physical contact of a transfer arm with reaction products or other foreign matters accumulated at an outer peripheral edge portion of a wafer being transferred, a transfer arm configured to transfer a wafer while holding a rear surface of the wafer has heretofore been proposed (refer to Japanese Laid-open Patent Publication No. 2000-3951, for example).

With use of the aforesaid prior arts, it is possible to reduce particles produced in the substrate processing apparatus.

In the case of using the prior arts in combination, however, wafer portions to which the protrusions of the electrostatic chuck contact overlap wafer portions to which the holder of the transfer arm contact. As understood from the foregoing explanations, particles are easily produced in the substrate processing apparatus when the transfer arm is brought in physical contact with particles having been attached to the wafer from the protrusions of the electrostatic chuck. In addition, such particles are produced suddenly. This makes it difficult to perform control for suppressing particles from being produced. When a large amount of particles is produced during mass processing of wafers, the yield of final products is inevitably lowered.

### SUMMARY OF THE INVENTION

The present invention provides a substrate transferring apparatus capable of suppressing particles from being produced, a substrate processing apparatus having the substrate transferring apparatus, and a substrate processing method for the substrate processing apparatus.

According to a first aspect of the present invention, there is provided a substrate transferring apparatus for transferring a substrate being processed to a stage disposed in a processing chamber and having a first holder adapted to hold the substrate being processed, the substrate transferring apparatus comprising a second holder adapted to hold portions of the substrate being processed that are different from portions of the substrate being processed which are held by the first holder of the stage.

With the substrate transferring apparatus of the present invention, the second holder of the substrate transferring apparatus holds substrate portions different from substrate portions held by the first holder of the stage. This makes it possible to prevent the substrate portions held by the second holder of the substrate transferring apparatus and the substrate portions held by the first holder of the stage from overlapping one another. As a result, the substrate transferring apparatus can be prevented from being in physical contact with particles having been attached to substrate portions while the substrate was mounted to the stage, thereby preventing the particles from being peeled off from the substrate being processed, thus preventing particles from being produced in the substrate processing apparatus.

The second holder can be adapted to hold the portions of the substrate being processed which are not an outer peripheral portion of the substrate being processed.

In this case, the second holder of the substrate transferring apparatus holds portions of the substrate being processed which are different from an outer peripheral edge portion of the substrate. This prevents the substrate transferring apparatus from being in physical contact with reaction products attached to the outer peripheral edge portion of the substrate during and/or after the processing on the substrate, thereby making it possible to prevent particles from being produced due to physical contact of the substrate transferring apparatus with the reaction products.

Each of the first and second holders can be comprised of a plurality of protrusions.

In this case, since the first holder of the stage and the second holder of the substrate transferring apparatus are each comprised of protrusions, it is possible to reduce particle attached to the substrate being processed when the substrate is held by the first and second holders.

Each of the first and second holders can be comprised of a plurality of annular protrusions.

In this case, since the first holder of the stage and the second holder of the substrate transferring apparatus are each comprised of annular protrusions, it is possible to reduce particle attached to the substrate being processed when the substrate is held by the first and second holders. In addition, since the first holder of the stage is comprised of annular protrusions, it is possible to divide a space between the stage and the substrate into a plurality of spaces, making it possible to individually control the pressure of heat-transmitting gas supplied to each of these spaces.

According to a second aspect of the present invention, there is provided a substrate processing apparatus comprising a processing chamber having therein a stage on which a substrate being processed is mounted, and a substrate transferring apparatus adapted to transfer the substrate being processed, wherein the substrate transferring apparatus is configured that the substrate being processed is mounted at portions on the substrate transferring apparatus that are different from portions of the substrate being processed at which the substrate being processed is mounted on the stage.

With the substrate processing apparatus of the present invention, substrate portions mounted on the substrate transferring apparatus are different from substrate portions mounted on the stage. This makes it possible to prevent the substrate portions mounted on the substrate transferring apparatus and the substrate portions mounted on the stage from overlapping one another. As a result, the substrate transferring apparatus can be prevented from being in physical contact with particles having been attached to the substrate being processed while the substrate was mounted to the stage, thereby preventing the particles from being peeled off from the substrate being processed, thus preventing particles from being produced in the substrate processing apparatus.

According to a third aspect of the present invention, there is provided a substrate processing method for a substrate processing apparatus comprising a processing chamber having therein a stage on which a substrate being processed is mounted, and a substrate transferring apparatus adapted to transfer the substrate being processed, the method comprising a first mounting step of mounting the substrate being processed on the stage, and a second mounting step of mounting the substrate being processed at portions on the substrate transferring apparatus that are different from portions of the substrate being processed at which the substrate being processed is mounted on the stage.

Further features of the present invention will become apparent from the following description of an exemplary embodiment with reference to the attached drawings.

### BRIEF DESCRIPTION OF THE DRAWINGS

FIG. 1 is a plan view schematically showing the construction of a substrate processing apparatus having a substrate transferring apparatus according to one embodiment of the present invention;

FIG. 2 is a section view schematically showing the construction of a process ship for subjecting a wafer to RIE processing;

FIG. 3A is a plan view showing an electrostatic chuck and a transfer fork in the embodiment;

FIG. 3B is an enlarged view showing a portion A in FIG. 3A;

FIG. 4 is a side view showing the electrostatic chuck and the transfer fork by which a wafer is held;

FIG. 5A is a plan view showing a modification of the electrostatic chuck and the transfer fork shown in FIG. 3;

FIG. 5B is an enlarged view showing a portion B in FIG. 5A; and

FIG. 6 is a plan view schematically showing the construction of a modification of the substrate processing apparatus having the substrate transferring apparatus of the embodiment.

### DETAILED DESCRIPTION OF THE PREFERRED EMBODIMENT

The present invention will now be described in detail below with reference to the drawings showing a preferred embodiment thereof.

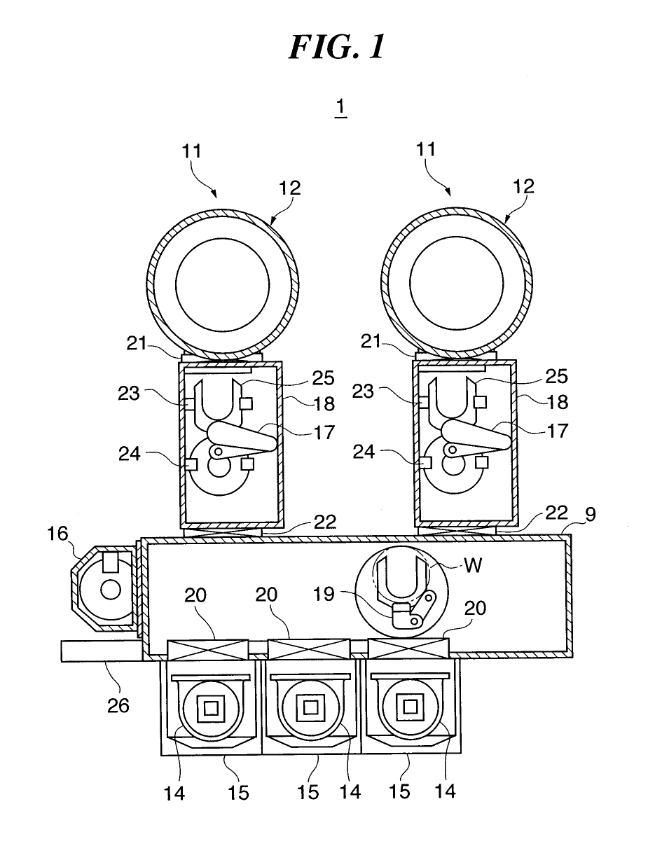

FIG. 1 is a plan view schematically showing the construction of a substrate processing apparatus having a substrate transferring apparatus according to one embodiment of the present invention.

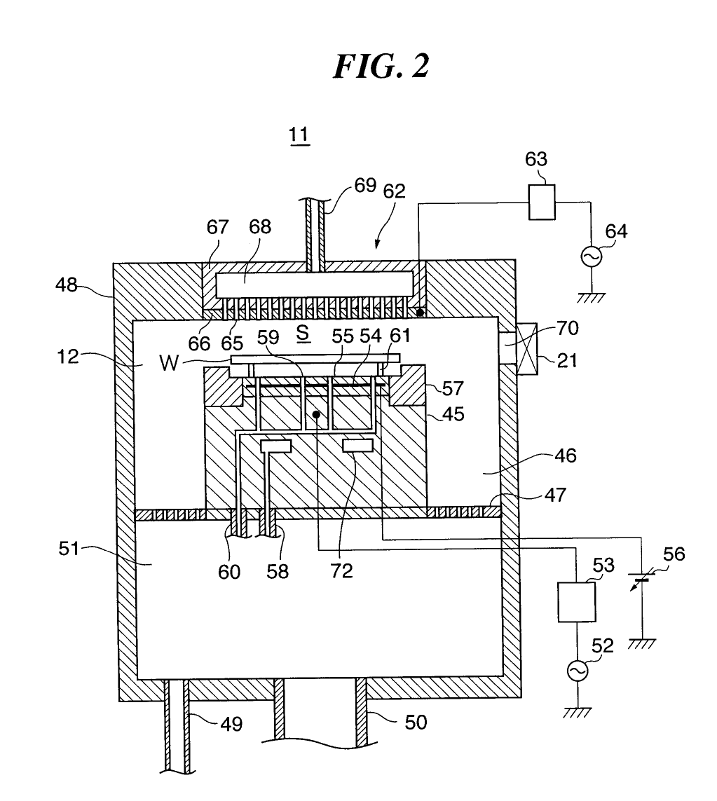

Referring to FIG. 1, the substrate processing apparatus 1 is comprised of a plurality of process ships 11 (FIG. 2) for subjecting a semiconductor device wafer (hereinafter simply referred to as the “wafer”) to reactive ion etching (hereinafter referred to as the “RIE”), and a loader unit 9 which is a rectangular-shaped common transfer chamber to which the process ships 11 are connected.

In addition to the process ships 11, the loader unit 9 has connected thereto three FOUP mounting stages 15 on each of which is mounted a FOUP (front opening unified pod) 14 that is a container for housing twenty-five of the wafers W, and an orienter 16 that carries out pre-alignment of the position of each wafer W transferred out from a FOUP 14.

The process ships 11 are connected to a side wall of the loader unit 9, and are disposed facing the three FOUP mounting stages 15 with the loader unit 9 therebetween. The orienter 16 is disposed at one end of the loader unit 9 in a longitudinal direction of the loader unit 9.

The loader unit 9 includes a transfer arm mechanism 19 disposed therein as a substrate transferring apparatus adapted to transfer wafers W, and three loading ports 20 disposed in a side wall of the loader unit 9 in correspondence with the FOUP mounting stages 15. The transfer arm mechanism 19 removes a wafer W from a FOUP 14 mounted on a FOUP mounting stage 15 through the corresponding loading port 20, and transfers the removed wafer W into and out of the process ships 11 and the orienter 16.

Each of the process ships 11 includes a processing chamber 12 as a vacuum vessel in which the wafer W is subjected to RIE processing, and a load lock unit 18 in which is housed a transfer arm 17 as a substrate transferring apparatus through which the wafer W is handed to the processing chamber 12.

The internal pressure of the loader unit 9 is held at atmospheric pressure, whereas the internal pressure of the processing chamber 12 is held at vacuum in each process ship 11. To this end, the load lock unit 18 is provided with a vacuum gate valve 21 in a connecting part between the load lock unit 18 and the processing chamber 12, and an atmospheric gate valve 22 in a connecting part between the load lock unit 18 and the loader unit 9, whereby the load lock unit 18 is constructed as a preliminary vacuum transfer chamber whose internal pressure can be adjusted.

Within the load lock unit 18, the transfer arm 17 is disposed in a central portion of the first load lock unit 18, first buffers 23 are disposed toward the processing chamber 12 with respect to the transfer arm 17, and second buffers 24 are disposed toward the loader unit 9 with respect to the transfer arm 17. The first and second buffers 23 and 24 are disposed above a track along which a transfer fork 25 (mentioned later) moves. After having being subjected to the RIE processing, each wafer W is temporarily laid by above the track of the transfer fork 25, whereby swapping over of the wafer W that has been subjected to the RIE processing and a wafer W yet to be subjected to the RIE processing can be carried out smoothly in the processing chamber 12.

The substrate processing apparatus includes a system controller (not show), mentioned later, for controlling operations of the process ships 11, the loader unit 9, and the orienter 16 (hereinafter collectively referred to as the “component elements”), and an operation GUI (graphical user interface) 26 disposed at one longitudinal end of the loader unit 9.

The system controller controls operations of the component elements in accordance with a program corresponding to the RIE processing. The operation GUI 26 includes a touch panel display (not shown) comprised of, for example, an LCD (liquid crystal display), and a display stand (not shown) that supports the touch panel display. Operation states of the component elements are displayed on the touch panel display, and an operator input is received through the touch panel display.

FIG. 2 is a section view schematically showing the construction of each process ship 11 for subjecting a wafer W to RIE processing.

Referring to FIG. 2, the process ship 11 includes a processing chamber 12 in which a wafer W is housed. In the processing chamber 12, there is provided a cylindrical susceptor 45 as a stage on which the wafer W is mounted.

In the process ship 11, a side exhaust path 46 that acts as a flow path through which gas above the susceptor 45 is exhausted out of the chamber 12 is formed between an inner wall of the chamber 12 and a side face of the susceptor 45. A baffle plate 47 is disposed part way along the side exhaust path 46.

The baffle plate 47 is a plate-shaped member having a large number of holes therein, and acts as a partitioning plate that partitions the processing chamber 12 into an upper portion and a lower portion. The upper portion 48 of the processing chamber 12 partitioned by the baffle plate 47 has disposed therein the susceptor 45 on which the wafer W is mounted, and has plasma produced therein. Hereinafter, the upper portion of the processing chamber 12 is referred to as the “reaction chamber”. Opened to the lower portion (hereinafter referred to as the “manifold”) 51 of the processing chamber 12 are a roughing exhaust pipe 49 and a main exhaust pipe 50 that exhaust gas out from the processing chamber 12. The roughing exhaust pipe 49 has a DP (dry pump) (not shown) connected thereto, and the main exhaust pipe 50 has a TMP (turbo-molecular pump) (not shown) connected thereto. The baffle plate 47 captures or reflects ions and radicals produced in a processing space S, described below, in the reaction chamber 48, thus preventing leakage of the ions and radicals into the manifold 51.

The roughing exhaust pipe 49, the main exhaust pipe 50, the DP, the TMP, and so on together constitute an exhausting apparatus. The roughing exhaust pipe 49 and the main exhaust pipe 50 exhaust gas in the reaction chamber 48 out of the processing chamber 12 via the manifold 51. Specifically, the roughing exhaust pipe 49 reduces the pressure in the processing chamber 12 from atmospheric pressure down to a low vacuum state, and the main exhaust pipe 50 cooperates with the roughing exhaust pipe 49 to reduce the pressure in the processing chamber 12 from atmospheric pressure down to a high vacuum state (e.g. a pressure of not more than 133 Pa (1 torr)), which is at a lower pressure than the low vacuum state.

A lower radio frequency power source 52 is connected to the susceptor 45 via a matcher 53. The lower radio frequency power source 52 supplies predetermined radio frequency electrical power to the susceptor 45. The susceptor 45 thus acts as a lower electrode. The matcher 53 reduces reflection of the radio frequency electrical power from the susceptor 45 so as to maximize the efficiency of the supply of the radio frequency electrical power into the susceptor 45.

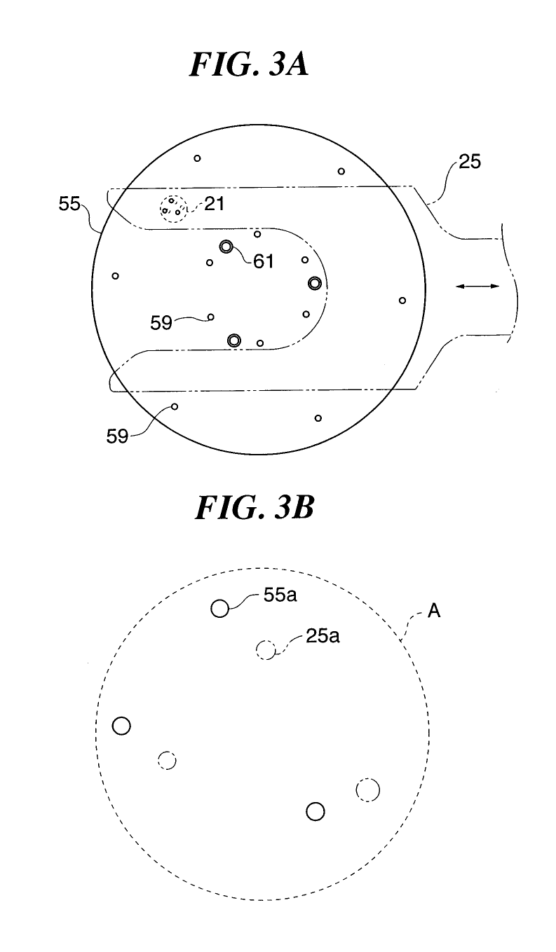

Provided in an upper portion of the susceptor 45 is a disk-shaped electrostatic chuck 55 (explained later referring to FIG. 3) made of an insulating material, for example yttria, alumina (Al₂O₃) or silica (SiO₂), having an electrode plate 54 therein. When a wafer W is mounted on the susceptor 45, the wafer W is disposed on the electrostatic chuck 55. A DC power source 56 is electrically connected to the electrode plate 54. Upon a negative DC voltage being applied to the electrode plate 54, a positive potential is produced on the rear surface of the wafer W, and a negative potential is produced on the front surface of the wafer. A potential difference thus arises between the electrode plate 54 and the rear surface of the wafer W, and hence the wafer W is attracted to and held on an upper surface of the electrostatic chuck 55 through a Coulomb force or a Johnsen-Rahbek force due to the potential difference.

Moreover, an annular focus ring 57 is provided on an upper portion of the susceptor 45 so as to surround the wafer W attracted to and held on the electrostatic chuck 55. The focus ring 57 is exposed to the processing space S, and focuses plasma in the processing space S toward the front surface of the wafer W, thus improving the efficiency of the RIE processing.

An annular coolant chamber 72 that extends, for example, in a circumferential direction of the susceptor 45 is provided inside the susceptor 45. A coolant, for example cooling water or a Galden® fluid, at a predetermined temperature is circulated through the coolant chamber 72 via coolant piping 58 from a chiller unit (not shown). A processing temperature of the wafer W attracted to and held on the electrostatic chuck 55 is controlled through the temperature of the coolant.

A plurality of protrusions 55a (FIG. 3B) for holding a wafer W are provided in a portion of the electrostatic chuck 55 on which the wafer W is attracted and held (hereinafter referred to as the “attracting surface”) By holding the wafer W by the protrusions 55a, particles attached from the electrostatic chuck 55 to the rear surface of the wafer W can be reduced.

A plurality of heat-transmitting gas supply holes 59 are opened to a portion of the electrostatic chuck 55 on which the wafer W is attracted and held. The heat-transmitting gas supply holes 59 are connected to a heat-transmitting gas supply unit (not shown) by a heat-transmitting gas supply line 60. The heat-transmitting gas supply unit supplies helium gas as a heat-transmitting gas via the heat-transmitting gas supply holes 59 into a gap between the attracting surface of the electrostatic chuck 55 and the rear surface of the wafer W. The helium gas supplied into the gap between the attracting surface of the electrostatic chuck 55 and the rear surface of the wafer W transmits heat from the wafer W to the susceptor 45 via the electrostatic chuck 55.

A plurality of pusher pins 61 are provided in the attracting surface of the susceptor 45 as lifting pins that can be made to project out from the electrostatic chuck 55. At a predetermined handover position on the pusher pins 61, the wafer W is handed to and from the transfer fork 25 disposed on the distal end of the transfer arm 17. The pusher pins 61 are connected to a motor (not shown) by a ball screw (not shown), and can be made to project out from the attracting surface of the susceptor 45 through rotational motion of the motor, which is converted into linear motion by the ball screw. The pusher pins 61 are housed inside the susceptor 45 when a wafer W is being attracted to and held on the attracting surface of the susceptor 45 so that the wafer W can be subjected to the RIE processing, and are made to project out from the electrostatic chuck 55 so as to lift the wafer W up away from the susceptor 45 when the wafer W is to be transferred out from the processing chamber 12 after having been subjected to the RIE processing.

A gas introducing shower head 62 is disposed in a ceiling portion of the processing chamber 12 (the reaction chamber 48) such as to face the susceptor 45. An upper radio frequency power source 64 is connected to the gas introducing shower head 62 via a matcher 63. The upper radio frequency power source 64 supplies predetermined radio frequency electrical power to the gas introducing shower head 62. The gas introducing shower head 62 thus acts as an upper electrode. The matcher 63 has a similar function to the matcher 53, described earlier.

The gas introducing shower head 62 has a ceiling electrode plate 66 having a large number of gas holes 65 therein, and an electrode support 67 on which the ceiling electrode plate 66 is detachably supported. A buffer chamber 68 is provided inside the electrode support 67. A processing gas introducing pipe 69 is connected to the buffer chamber 68. A processing gas supplied from the processing gas introducing pipe 69 into the buffer chamber 68 is supplied by the gas introducing shower head 62 into the processing chamber 12 (the reaction chamber 48) via the gas holes 65.

A wafer transfer port 70 is provided in a side wall of the processing chamber 12 in a position at the height of a wafer W that has been lifted up from the susceptor 45 by the pusher pins 61. The gate valve 21, which is for opening and closing the transfer port 70, is provided in the transfer port 70.

In the processing chamber 12 of the process ship 11, radio frequency electrical power is supplied to the susceptor 45 and the gas introducing shower head 62 as described above so as to apply radio frequency electrical power into the processing space S between the susceptor 45 and the gas introducing shower head 62, whereupon the processing gas supplied into the processing space S from the gas introducing shower head 62 is turned into high-density plasma, whereby ions and radicals are produced; the wafer W is subjected to the RIE processing by the ions and so on.

In the following, the shape of the transfer fork 25 in the transfer arm 17, which is the substrate transferring apparatus of this embodiment, and the shape of the electrostatic chuck 55 in this embodiment will be explained.

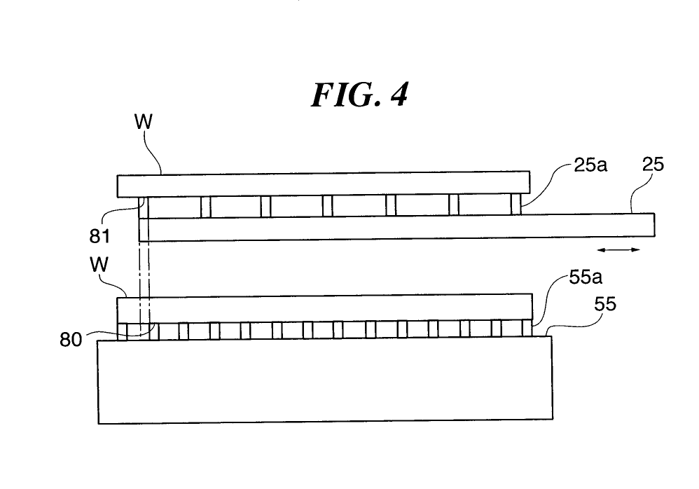

FIG. 3A is a plan view showing the electrostatic chuck 55 and the transfer fork 25 in this embodiment, and FIG. 3B is an enlarged view showing a portion A in FIG. 3A. FIG. 4 is a side view showing the electrostatic chuck 55 and the transfer fork 25 by each of which a wafer W is held.

As shown in FIGS. 3 and 4, the electrostatic chuck 55 is provided at its attracting surface with a plurality of protrusions 55a (FIG. 3B) for holding a wafer W, so that the wafer W is held by the protrusions 55a as shown in FIG. 4. On the attracting surface of the electrostatic chuck 55, the aforementioned three pusher pins 61 are arranged coaxially around the center of the electrostatic chuck 55. In a case that wafers each having 300 mm diameter are processed in this embodiment, the electrostatic chuck 55 has its diameter of 300 mm, the protrusions 55a each have a width of about 1 mm, the pusher pins 61 each have a diameter of 2 mm to 3 mm, and the three pusher pins 61 have a PCD (pitch circle diameter) of about 170 mm, wherein the PCD of the three pusher pins 61 has a radius corresponding to a distance between the center of each of the pusher pins 61 and the center of the electrostatic chuck 55.

The transfer forks 25 are each provided with a plurality of protrusions 25a (FIG. 3B) for holding a wafer W. The wafer W is held by the protrusions 25a as shown in FIG. 4. The protrusions 25a are large enough in number to hold the wafer W being transferred. In the case of wafers each having a 300 mm diameter being processed in this embodiment, each protrusion 25a has a width of about 7 mm, and the transfer fork 25 has an outer width of about 270 mm and an inner width of about 200 mm.

The protrusions 25a of the transfer fork 25 are arranged in such a manner that portions 81 of a wafer W which are held by the protrusions 25a of the transfer fork 25 are different from portions 80 of the wafer W which are held by the protrusions 55a of the electrostatic chuck 55. Specifically, the protrusions 25a are provided in the transfer fork 25 such that these protrusions 25a are different in position from the protrusions 55a of the electrostatic chuck 55 as seen from above, with the transfer fork 25 positioned at the predetermined handover position where the wafer W is handed over between the transfer fork 25 and the electrostatic chuck 55. Thus, the wafer portions held by the protrusions 25a of the transfer fork 25 are made different in position from the wafer portions held by the protrusions 55a of the electrostatic chuck 55.

According to the present embodiment, the protrusions 25a of the transfer fork 25 hold wafer portions 81 which are different in position from wafer portions 80 held by the protrusions 55a of the electrostatic chuck 55. This makes it possible to prevent the wafer portions 81, 80 respectively held by the protrusions 25a of the transfer fork 25 and the protrusions 55a of the electrostatic chuck 55 from overlapping one another. As a result, it is possible to prevent the transfer fork 25 from being in physical contact with particles having been attached to portions 80 of a wafer W mounted to the electrostatic chuck 55, to thereby prevent the particles from being peeled off from the wafer W, making it possible to suppress particles from being produced in the substrate processing apparatus.

In this embodiment, the protrusions 25a of the transfer fork 25 are arranged such as to hold the wafer portions 81 that are different from the wafer portions 80 held by the protrusions 55a of the electrostatic chuck 55. Preferably, the protrusions 25a of the transfer fork 25 are configured to hold wafer portions that are different in position not only from the wafer portions 80 held by the protrusions 55a of the electrostatic chuck 55, but also from wafer portions held by other wafer holding members such as rubber pins of the orienter 16 that carries out pre-alignment of the wafer W.

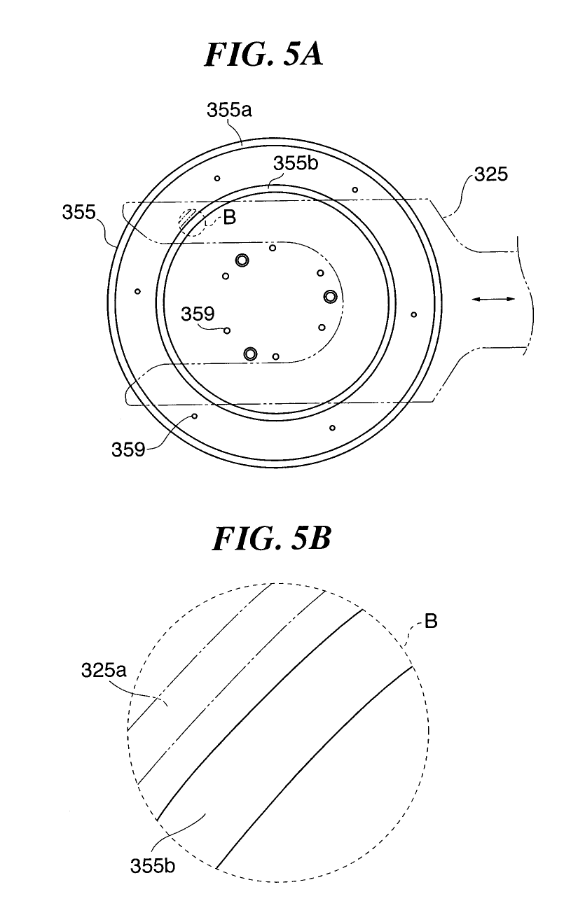

FIG. 5A is a plan view showing a modification of the electrostatic chuck 55 and the transfer fork 25 shown in FIG. 3, and FIG. 5B is an enlarged view showing a portion B in FIG. 5A.

As shown in FIG. 5, an electrostatic chuck 355 is provided at an outer peripheral edge of the attracting surface with a first annular protrusion 355a for holding a wafer W and a second annular protrusion 355b formed inwardly of and concentrically with the first annular protrusion 355a. In the electrostatic chuck 355, a wafer W is held by the first and second annular protrusions 355a and 355b.

On the other hand, a transfer fork 325 includes annular protrusions 325a (FIG. 5B) for holding a wafer W, so that the wafer W is held by the annular protrusions 325a. The annular protrusions 325a which are disposed concentrically with one another are large enough in number to hold a wafer W being transferred.

The annular protrusions 325a are provided in the transfer fork 325 such that wafer portions held by the annular protrusions 325a are different in position from wafer portions held by the first and second annular protrusions 355a and 355b of the electrostatic chuck 355. Specifically, the annular protrusions 325a are provided in the transfer fork 325 such that the protrusions 325a are different in position from the first and second annular protrusions 355a and 355b of the electrostatic chuck 355 as seen from above, with the transfer fork 325 positioned at the predetermined handover position where the wafer W is handed over between the transfer fork 325 and the electrostatic chuck 355. Thus, the wafer portions held by the protrusions 325a of the transfer fork 325 are made different in position from the wafer portions held by the first and second annular protrusions 355a and 355b of the electrostatic chuck 355.

According to this modification, the annular protrusions 325a of the transfer fork 325 hold wafer portions which are different in position from wafer portions held by the first and second annular protrusions 355a and 355b of the electrostatic chuck 355. This makes it possible to prevent the wafer portions held by the annular protrusions 325a of the transfer fork 325 and the wafer portions held by the first and second annular protrusions 355a and 355b of the electrostatic chuck 355 from overlapping one another. As a result, it is possible to attain advantages which are the same as or similar to those attained by the aforementioned embodiment.

In addition, since the electrostatic chuck 355 in this modification includes the first and second annular protrusions 355a and 355b, it is possible to divide a space between the electrostatic chuck 355 and the wafer W into two spaces by the first and second annular protrusions 355a and 355b, making it possible to individually control the pressure of heat-transmitting gas supplied to each of the two spaces.

In this modification, the annular protrusions 325a of the transfer fork 325 are arranged such as to hold wafer portions that are different in position from wafer portions held by the first and second annular protrusions 355a and 355b of the electrostatic chuck 355. Preferably, the annular protrusions 325a of the transfer fork 325 are configured to hold wafer portions that are different in position not only from wafer portions held by the first and second annular protrusions 355a and 355b of the electrostatic chuck 355, but also from wafer portions held by other wafer holding members such as rubber pins of the orienter 16 that carries out pre-alignment of the wafer W.

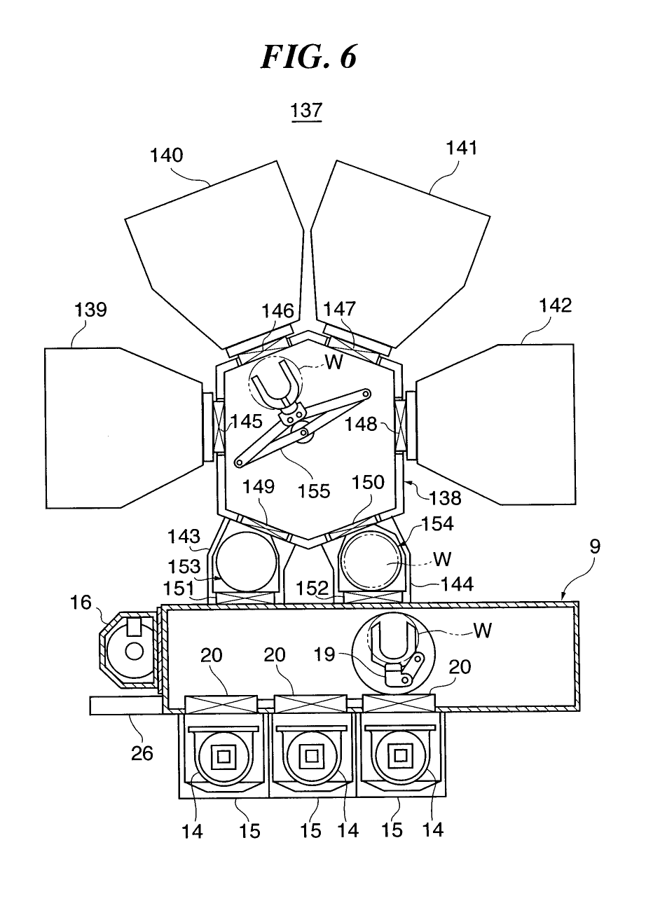

The substrate processing apparatus having the substrate transferring apparatus according to the aforementioned embodiment is not limited to being applied to a parallel-type substrate processing apparatus having two process ships disposed parallel to each other as shown in FIG. 1, but may be applied to a substrate processing apparatus having a plurality of processing units disposed radially as shown in FIG. 6, which are vacuum processing chambers in which predetermined processing is performed on the wafer W

FIG. 6 is a plan view schematically showing the construction of a modification of the substrate processing apparatus having the substrate transferring apparatus of the aforementioned embodiment. In FIG. 6, component elements which are the same as or similar to corresponding component elements of the substrate processing apparatus 1 shown in FIG. 1 are denoted by corresponding reference numerals, and explanations thereof will be omitted.

Referring to FIG. 6, a substrate processing apparatus 137 is comprised of a transfer unit 138 having a hexagonal plan view, four processing units 139 to 142 in which the wafer W is subjected to predetermined processing and which are arranged radially around the transfer unit 138, a loader unit 9 as a rectangular-shaped common transfer chamber, and two load lock units 143 and 144 that are each disposed between the transfer unit 138 and the loader unit 9 so as to link these units 138, 9 together.

The internal pressure of the transfer unit 138 and each of the processing units 139 to 142 is held at vacuum. The transfer unit 138 is connected to the processing units 139 to 142 by vacuum gate valves 145 to 148 respectively.

In the substrate processing apparatus 137, the internal pressure of the loader unit 9 is held at atmospheric pressure, whereas the internal pressure of the transfer unit 138 is held at vacuum. The load lock units 143 and 144 are thus provided respectively with a vacuum gate valve 149 or 150 in a connecting part between that load lock unit and the transfer unit 138, and an atmospheric door valve 151 or 152 in a connecting part between that load lock unit and the loader unit 9, whereby the load lock units 143 and 144 are each constructed as a preliminary vacuum transfer chamber whose internal pressure can be adjusted. Moreover, the load lock units 143 and 144 have respectively therein a wafer mounting stage 153 or 154 for temporarily mounting a wafer W being transferred between the loader unit 9 and the transfer unit 138.

The transfer unit 138 has disposed therein a frog leg-type transfer arm 155 that can bend/elongate and turn. The transfer arm 155 transfers the wafers W between the processing units 139 to 142 and the load lock units 143 and 144.

Each of the processing units 139 to 142 has respectively therein a mounting stage (not shown) on which is mounted a wafer W to be processed. Here, the processing units 139 and 140 are each constructed like the process ships 11 in the substrate processing apparatus 1.

Operations of the component elements in the substrate processing apparatus 137 are controlled using a system controller constructed like the system controller in the substrate processing apparatus 1.

What is claimed is:

1. A substrate transferring apparatus for transferring a substrate being processed to a stage disposed in a processing chamber and having a first holder adapted to hold the substrate being processed, comprising:
a second holder adapted to hold portions of the substrate being processed that are different from portions of the substrate being processed which are held by the first holder of the stage.

2. The substrate transferring apparatus according to claim 1, wherein said second holder is adapted to hold the portions of the substrate being processed which are not an outer peripheral portion of the substrate being processed.

3. The substrate transferring apparatus according to claim 1, wherein each of the first and second holders is comprised of a plurality of protrusions.

4. The substrate transferring apparatus according to claim 1, wherein each of the first and second holders is comprised of a plurality of annular protrusions.

5. A substrate processing apparatus comprising a processing chamber having therein a stage on which a substrate being processed is mounted, and a substrate transferring apparatus adapted to transfer the substrate being processed, wherein:
said substrate transferring apparatus is configured that the substrate being processed is mounted at portions on said substrate transferring apparatus that are different from portions of the substrate being processed at which the substrate being processed is mounted on the stage.

6. The substrate processing apparatus according to claim 5, wherein the substrate being processed is mounted at portions on said substrate transferring apparatus that are not an outer peripheral portion of the substrate being processed.

7. The substrate processing apparatus according to claim 5, wherein said stage has a portion thereof adapted to be mounted with the substrate being processed and formed with a plurality of protrusions, and said substrate transferring apparatus has a portion thereof adapted to be mounted with the substrate being processed and formed with a plurality of protrusions.

8. The substrate processing apparatus according to claim 5, wherein said stage has a portion thereof adapted to be mounted with the substrate being processed and formed with a plurality of annular protrusions are formed, and said substrate transferring apparatus has a portion thereof adapted to be mounted with the substrate being processed and formed with a plurality of annular protrusions.

9. A substrate processing method for a substrate processing apparatus comprising a processing chamber having therein a stage on which a substrate being processed is mounted, and a substrate transferring apparatus adapted to transfer the substrate being processed, the method comprising:
a first mounting step of mounting the substrate being processed on the stage; and
a second mounting step of mounting the substrate being processed at portions on the substrate transferring apparatus that are different from portions of the substrate being processed at which the substrate being processed is mounted on the stage.

10. The substrate processing method according to claim 9, wherein, in said second mounting step, the substrate being processed is mounted at portions on the substrate transferring apparatus that are not an outer peripheral portion of the substrate being processed.

11. The substrate processing method according to claim 9, wherein, in said first mounting step, the substrate being processed is mounted on a plurality of protrusions formed on the stage, and in said second mounting step, the substrate being processed is mounted on a plurality of protrusions formed on the substrate transferring apparatus.

12. The substrate processing method according to claim 9, wherein, in said first mounting step, the substrate being processed is mounted on a plurality of annular protrusions formed on the stage, and in said second mounting step, the substrate being processed is mounted on a plurality of annular protrusions formed on the substrate transferring apparatus.
